(19) United States
(12) Patent Application Publication
(10) Pub. No.: US 2004/0056540 A1
(43) Pub. Date: Mar. 25, 2004

(54) Device with a suppressor for reducing interference

(76) Inventors: Ernst Kraenzler, Leinfelden-Echterdingen (DE); Dietmar Saur, Heinrich-Heine-Strasse (DE); Hardy Schmid, Stuttgart (DE)

Correspondence Address: Striker Striker & Stenby, 103 East Neck Road, Huntington, NY, 11743, US

(21) Appl. No.: 10/451,870

(22) PCT Filed: Jun. 28, 2002
(86) PCT No.: PCT/DE02/02361

(30) Foreign Application Priority Data
Oct. 11, 2001 (DE) 101-50-237.0

(51) Int. Cl. H02K 5/24; H02K 11/00

(52) U.S. Cl. 310/51; 318/629; 310/71; 361/23

(57) ABSTRACT

The invention relates to a device comprising at least one suppressor (10, 12) for reducing interference, especially in the high-frequency range of an electric machine (18), and also comprising at least one connection element (14, 16) for connection to a pole shoe of the electric machine (18).

According to the invention, the suppressor (10, 12) is secured in a receiving area (20, 22) of the connection element (14, 16) which is provided with a plug-in element (24, 26) for connection to the pole shoe and is combined therewith to form a module (28, 30, 32, 34).

### BACKGROUND OF THE INVENTION

The invention relates to a device with a suppressor for reducing interference according to the preamble of claim 1.

In order to reduce interference in the high-frequency range in electric motors, it is known to electrically connect two suppressors in a supply lead of the electric motor between a pole shoe and a commutator of the electric motor. The suppressors are secured separately from each other in cartridges in a motor housing and comprise connection cables having different lengths. Each of the suppressors has a coil and a core.

### ADVANTAGES OF THE INVENTION

The invention relates to a device having at least one suppressor for reducing interference, especially in the high-frequency range of an electrical machine, and also comprising at least one connection element for connection to a pole shoe of the electric machine.

The invention provides that the suppressor is secured in a receiving area of the connection element which is provided with a plug-in element for connection to the pole shoe, and is combined therewith to form a module. Cables and fastening components can be spared, and a compact module that can be integrated in space-saving fashion is attained, which said module can be integrated particularly advantageously in hand power tools, and particularly in hand power tools that comprise an electric motor with a turnable brush plate which typically takes up more space than a fixed brush plate. The module can be situated advantageously close to a commutator of the electric machine and, therefore, to the source of interference, and a high level of efficiency of the suppressor can be attained.

With the module, simple and fast installation and removal can be attained, of other components and assemblies as well in particular, such as carbon brushes of the electrical machine, and a high level of electrical safety can be attained using a simple construction by the fact that current-carrying lines can be situated relatively far away from an outer housing, providing advantageous external protection.

Installation expenditure and the amount of space required can be further reduced by integrating a plug-in element in the connection element for connection to an armature and/or by integrating a plug-in element in the module for connection to a control switch. The plug-in element for connection to the armature of the electric machine can be mounted or, advantageously, integrally molded on the connection element, by way of which assembly expenditure can be avoided.

The plug-in elements can be formed out of various elements appearing reasonable to one skilled in the art, such as blade terminals or receptacles.

If the device comprises two constructionally identical modules, incorrect fitting resulting from the modules being mixed up can be advantageously prevented, and the number of different components and, therefore, the total cost, can be reduced.

The invention further provides that two modules are combined on a carrier unit to form one insertable unit, which allows them to be advantageously secured in a housing in one installation step and with few fastening elements.

The module or modules can be secured on a carrier unit formed by an additional component or, advantageously, on a component belonging to the electric machine, e.g., on a brush plate of the electric machine. The need for additional components can be prevented in this manner.

According to a further embodiment, the invention provides that at least part of the module is encapsulated in plastic. Encapsulation can provide advantageous protection against vibrations in particular. With encapsulation, it can furthermore be easily ensured that the components are correctly matched up with each other inside the module using few fastening elements. The module can be partially inserted into the connection plate and then encapsulated or, advantageously, it can be encapsulated at least partially by the connection plate. Assembly expenditure can be reduced in this manner.

The device can be used in various electric machines appearing reasonable to one skilled in the art, e.g., in alternators operated in the high-frequency range, for example. Due to the attainable compact construction, however, they can be used particularly advantageously in hand power tools.

### SUMMARY OF THE DRAWINGS

Further advantages result from the following description of the drawings. An exemplary embodiment of the invention is presented in the drawings. The drawings, the description, and the claims contain numerous features in combination. One skilled in the art will advantageously consider them individually as well and combine them into reasonable further combinations.

FIG. 1 is a side view of a schematic representation of an impact drill,

FIG. 2 is a module with a suppressor and a connection element,

FIG. 3 is the module in FIG. 2, mounted on a connection plate of an electric motor,

FIG. 4 is an alternative to the module shown in FIG. 2, comprising an integrated plug-in element for connection to a control switch, and

FIG. 5 is the module shown in FIG. 4, mounted on a connection plate.

### DESCRIPTION OF THE PREFERRED EMBODIMENTS

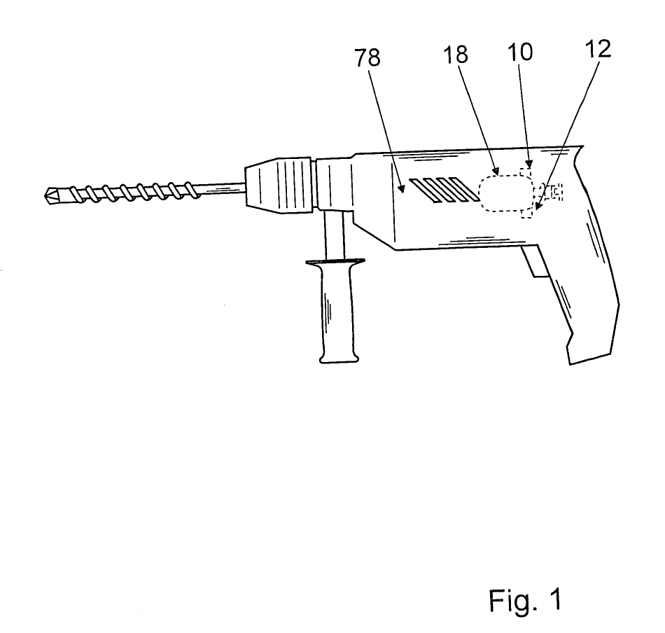

FIG. 1 is a side view of an impact drill shown in a schematic representation, comprising an electric motor 18 located in a housing 78, which said electric motor is equipped with a not-shown turnable brush plate. The impact drill comprises a device having two suppressors 10, 12 for reducing interference in the high-frequency range, each having a connection element 14, 16 for connection to a pole shoe of an electric motor 18 (FIGS. 1, 2, and 3).

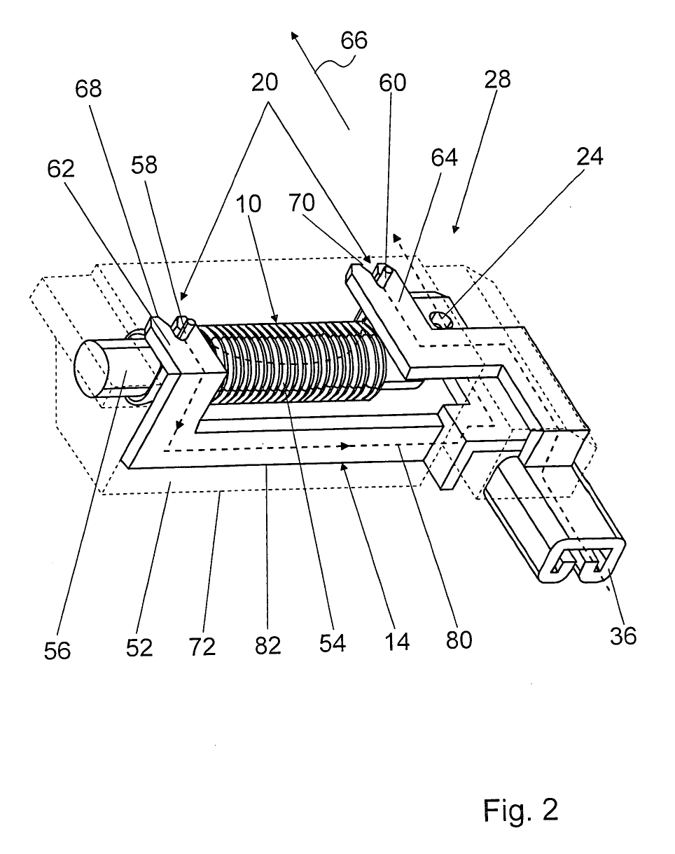

According to the invention, the suppressor 10, 12 is secured in a receiving area 20, 22 of the connection element 14, 16 which is provided with a plug-in element 24, 26 for connection to the pole shoe, and is combined therewith to form a module. The modules 28, 30 are constructionally identical. The design of the modules 28, 30 will be described hereinbelow using module 28 as an example (FIG. 2).

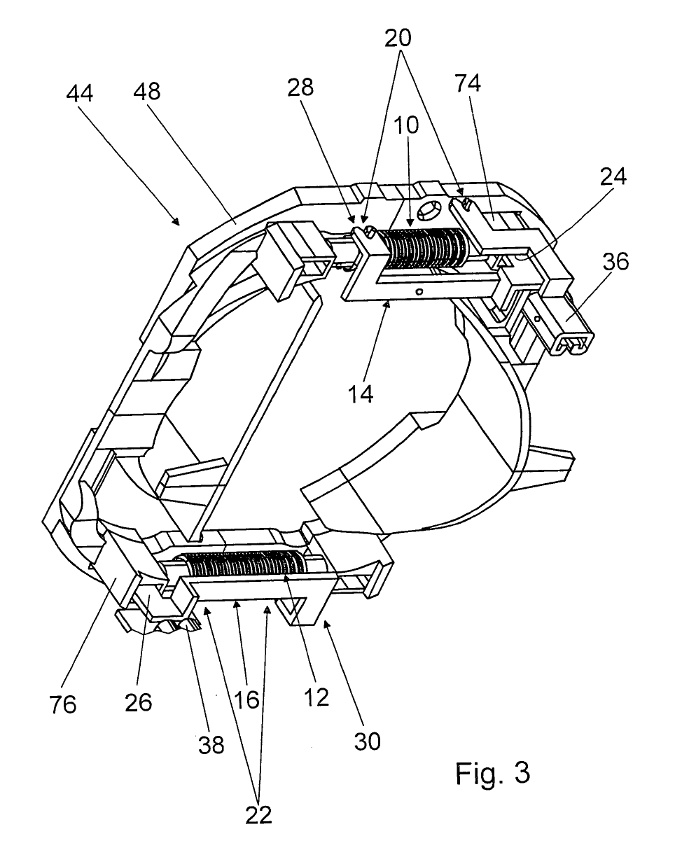

The suppressor 10, which is formed by a coil 54 and an iron core 56 enclosed by the coil 54, is inserted in the receiving area 20 of the connection element 14 when the module 28 is installed. The receiving area 20 is formed by two holding arms 62, 64 integrally molded on the connection element 14. The free ends of said holding arms point in the direction of insertion 66 of the module 28 into a connection plate 48 of the electric motor 18 (refer to FIGS. 2 and 3). The suppressor 10 is guided via ends 58, 60 of the coil 54 into notches 68, 70 formed in the free ends of the holding arms 62, 64. The holding arms 62, 64 are then crimped and soldered in the region of the notches 68, 70 to fix the suppressor 10 in position in the connection element 14 and to electrically connect said suppressor with said connection element.

Once the suppressor 10 is fixed in position in the receiving area 20 of the connection element 14 and combined with the connection element 14 to form a module 28, they are inserted into a housing 72 shown in FIG. 2, which said housing is then covered with plastic 52. The module 28 and/or the suppressor 10 and the connection element 14 are thereby advantageously protected from vibrations.

The module 28 and the constructionally identical module 30 are inserted via their plug-in elements 24, 26—formed as blade terminals—into the insertion sleeves 74, 76 integrally molded on the connection plate 48 of the electric motor 18 (FIG. 3). To enhance clarity, modules 28, 30 are shown in FIG. 3 without housing 72 or plastic encapsulation. Together with the connection plate 48, which is part of the stator, the two modules 28, 30 form a unit 44 which can then be pressed into the housing 78 of the impact drill in one installation step.

A plug-in element 36, 38 developed as insertion sleeve is integrally molded on each side of the connection element 14, 16 furthest from the plug-in element 24, 26, into which said plug-in element developed as insertion sleeve a not-shown plug-in element developed as blade terminal of the armature of the electric motor 18 can be inserted. In FIG. 2, current flow 80 from the armature through the module 28 to the pole shoe is shown schematically. Current flows from the plug-in element 36 through the holding arm 64 to the end 60 of the coil 54, through the coil 54 to the holding arm 62 and through the holding arm 62—one leg 82 of which extends parallel to the iron core 56 of the suppressor 10—to the plug-in element 24. If the direction of current flow changes, the current then flows in the opposite direction through the module 28.

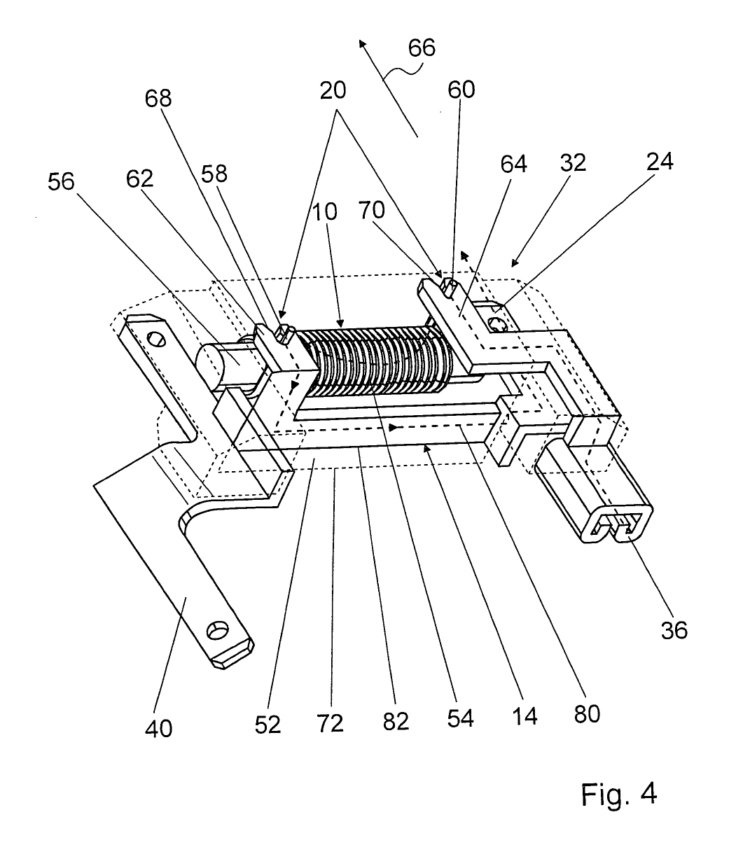

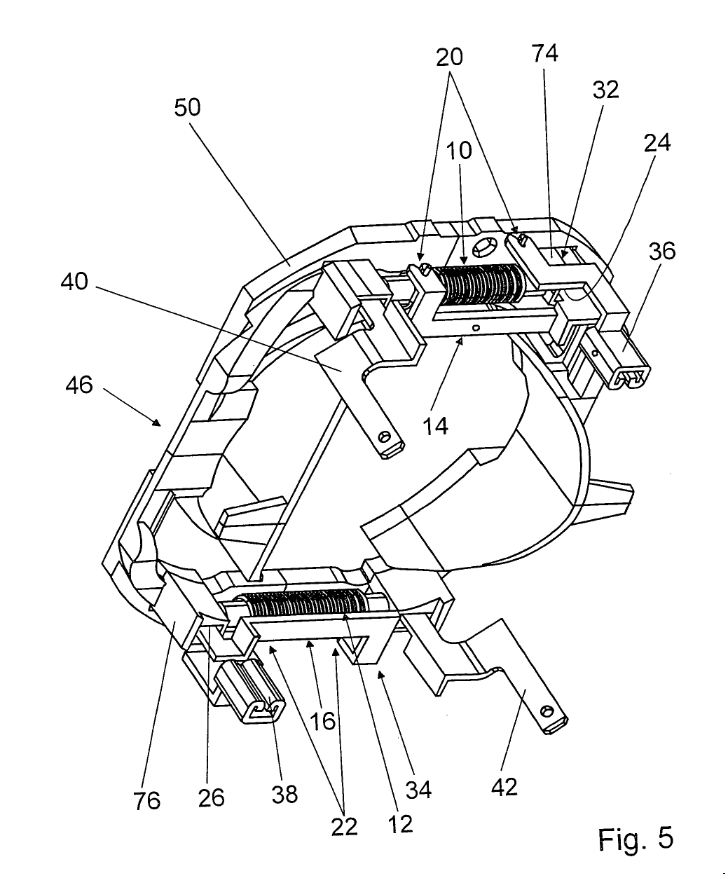

An alternative device is shown in FIGS. 4 and 5. Components that are essentially identical are labelled with the same reference numerals. Furthermore, reference is made to the description of the exemplary embodiment in FIGS. 1 through 3 with regard for features and functions that remain the same. The following description is essentially limited to the differences from the exemplary embodiment in FIGS. 1 through 3.

The device comprises two constructionally identical modules 32, 34 plugged into a connection plate 50 of an electric motor. Said modules, together with the connection plate 50, form a unit 46 capable of being inserted in a housing. Each of the modules 32, 34 comprises an integrated plug-in element 40, 42 designed as a 90-degree connector for connection to a control switch. The plug-in element 40 is placed in a housing 72 enclosing the module 32, and it is encapsulated as well when the module 32 and/or a suppressor 10 and a connection element 14 are encapsulated in plastic 52 (FIG. 4). The plug-in element 40 is electrically insulated from the suppressor 10 and the connection element 14 via the plastic 52.

### REFERENCE NUMERALS

| | |
|---|---|
| 10 | Suppressor |
| 12 | Suppressor |
| 14 | Connection element |
| 16 | Connection element |
| 18 | Electric motor |
| 20 | Receiving area |
| 22 | Receiving area |
| 24 | Plug-in element |
| 26 | Plug-in element |
| 28 | Module |
| 30 | Module |
| 32 | Module |
| 34 | Module |
| 36 | Plug-in element |
| 38 | Plug-in element |
| 40 | Plug-in element |
| 42 | Plug-in element |
| 44 | Unit |
| 46 | Unit |
| 48 | Connection plate |
| 50 | Connection plate |
| 52 | Plastic |
| 54 | Coil |
| 56 | Iron core |
| 58 | End |
| 60 | End |
| 62 | Holding arm |
| 64 | Holding arm |
| 66 | Direction of insertion |
| 68 | Notch |
| 70 | Notch |
| 72 | Housing |
| 74 | Insertion sleeve |
| 76 | Insertion sleeve |
| 78 | Housing |
| 80 | Current flow |
| 82 | Leg |

What is claimed is:

1. A device comprising at least one suppressor (10, 12) for reducing interference, especially in the high-frequency range of an electric machine (18), and also comprising at least one connection element (14, 16) for connection to a pole shoe of the electric machine (18),
wherein the suppressor (10, 12) is secured in a receiving area (20, 22) of the connection element (14, 16) which is provided with a plug-in element (24, 26) for connection to the pole shoe and is combined therewith to form a module (28, 30, 32, 34).

2. The device according to claim 1,
wherein the connection element (14, 16) is provided with a plug-in element (36, 38) for connection to an armature.

3. The device according to claim 2,
wherein the connection element (24, 26) is integrally molded on the connection element (14, 16) for connection to an armature.

4. The device according to one of the preceding claims,
wherein a plug-in element (40, 42) is integrated in the module (32, 34) for connection to a control switch.

5. The device according to one of the preceding claims,
wherein two constructionally identical modules (28, 30, 32, 34) are provided.

6. The device according to one of the preceding claims,
wherein two modules (28, 30, 32, 34) are combined on a carrier unit (48, 50) to form one insertable unit (44, 46).

7. The device according to one of the preceding claims,
wherein the module (28, 30, 32, 34) is located on a connection plate (48, 50) of the electrical machine (18).

8. The device according to one of the preceding claims,
wherein at least part of the module (28, 30, 32, 34) is encapsulated in plastic (52).

9. The device according to claim 6 or 7 or 8,
wherein at least part of the module is encapsulated by the connection plate.

10. A hand power tool having a device according to one of the preceding claims.
